(19) United States
(12) Patent Application Publication
(10) Pub. No.: US 2022/0156370 A1
(43) Pub. Date: May 19, 2022

(54) OBFUSCATED IDENTIFIER DETECTION METHOD BASED ON NATURAL LANGUAGE PROCESSING AND RECORDING MEDIUM AND APPARATUS FOR PERFORMING THE SAME

(71) Applicant: Foundation of Soongsil University-Industry Cooperation, Seoul (KR)

(72) Inventors: Jeong Hyun YI, Seoul (KR); Geochang JEON, Seoul (KR)

(21) Appl. No.: 17/278,781

(22) PCT Filed: Nov. 25, 2020
(86) PCT No.: PCT/KR2020/016745

§ 371 Date: Mar. 23, 2021

(30) Foreign Application Priority Data
Nov. 18, 2020 (KR) 10-2020-0154542

(51) Int. Cl. G06F 21/56; G06F 8/40; G06F 40/279; G06F 40/166

(52) U.S. Cl. CPC G06F 21/56; G06F 8/40; G06F 2221/033; G06F 40/166; G06F 40/279

(57) ABSTRACT

An obfuscated identifier detection method based on natural language processing includes: converting an input obfuscated apk to smali code level, inspecting an obfuscated string in identifiers of the smali code acquired from a smali code converter, extracting information necessary for deobfuscation and frequency of the identifiers when there is the obfuscated string, storing frequency, type and name information of identifiers calculated from information extracted from an unobfuscated apk, and acquiring and deobfuscating an identifier type name having a most similar frequency in an identifier name database (DB) using information extracted from an obfuscated information extractor. Accordingly, it is possible to reduce delay in analysis and achieve faster analysis by automatically renaming the code that is difficult to understand due to identifier conversion obfuscation.

### TECHNICAL FIELD

The present disclosure relates to an obfuscated identifier detection method based on natural language processing and a recording medium and an apparatus for performing the same, and more particularly, to an automated and efficient deobfuscation approach to solve the issue of the increasing number of malicious samples to analyze resulting from continuously emerging new malicious codes.

### BACKGROUND ART

Due to the abuse the identifier conversion obfuscation technique in malicious code, virus analyzers need more time to analyze the malicious code. The existing countermeasures include comprehending the meaning of all obfuscated code per package, class, and method, deobfuscating, and then analyzing the behavior of the malicious code. Additionally, even though the identifier conversion deobfuscation tool is used, the created names are deobfuscated in limited expressions or in difficult formats to semantically understand.

This method accomplishes deobfuscation but requires a large amount of time for behavioral analysis and conversion to a format which is easy to understand. With the continuous emergence of new malicious code, the number of malicious samples to analyze increases, and accordingly, there is a need for an automated deobfuscation approach for efficient analysis.

### RELATED LITERATURES

### Patent Literatures

(Patent Literature 1) KR 10-2020-0096766 A

(Patent Literature 2) KR 10-1027928 B1

(Patent Literature 3) KR 10-1113249 B1

### DISCLOSURE

### Technical Problem

In this circumstance, the present disclosure is directed to providing an obfuscated identifier detection method based on natural language processing.

The present disclosure is further directed to providing a recording medium having a computer program recorded thereon, the computer program for performing the obfuscated identifier detection method based on natural language processing.

The present disclosure is further directed to providing an apparatus for performing the obfuscated identifier detection method based on natural language processing.

### Technical Solution

To achieve the above-described object of the present disclosure, an obfuscated identifier detection method based on natural language processing according to an embodiment includes converting an input obfuscated apk to smali code level, inspecting an obfuscated string in identifiers of the smali code acquired from a smali code converter, extracting information necessary for deobfuscation and frequency of the identifiers when there is the obfuscated string, storing frequency, type and name information of identifiers calculated from information extracted from an unobfuscated apk, and acquiring and deobfuscating an identifier type name having a most similar frequency in an identifier name database (DB) using information extracted from an obfuscated information extractor.

In an embodiment of the present disclosure, converting to the smali code level may include decompiling the input obfuscated apk to a dex file, and converting the acquired dex file to smali code using baksmali, the smali code being a readable version of application execution code.

In an embodiment of the present disclosure, inspecting the obfuscated string may include inspecting all types in the dex file for the identifiers of package, class, method, field, abstract and implement type of the smali code.

In an embodiment of the present disclosure, inspecting the obfuscated string may further include determining the name of 2 letters or less or binary other than English alphabet and numbers in ASCII code value to be obfuscated.

In an embodiment of the present disclosure, extracting the information necessary for deobfuscation and the frequency of the identifiers may include recording the information necessary for deobfuscation in a log file, the information necessary for deobfuscation including at least one information of the apk name, the obfuscated name, the type, the number of code lines, a list of functions included in the method or a location address of a target.

In an embodiment of the present disclosure, extracting the information necessary for deobfuscation and the frequency of the identifiers may further include, when the inspection is performed for all types and the recording of the obfuscated information in the log file is completed, calculating the frequency of the identifiers using a Term Frequency-Inverse Document Frequency (TF-IDF) algorithm which is a natural language processing algorithm to split a string for each obfuscated information and calculate a ratio value of how many times the corresponding character appears in an entire document, and recording the calculated frequency of the identifiers in the log file.

In an embodiment of the present disclosure, the obfuscated identifier detection method based on natural language processing may further include receiving an input unobfuscated apk, extracting names and code in identifiers of package, class, method, field, abstract and implement type, and storing in the identifier name DB.

In an embodiment of the present disclosure, the obfuscated identifier detection method based on natural language processing may further include calculating the frequency of the identifiers using a TF-IDF algorithm which is a natural language processing algorithm based on the names and code extracted through the identifier data extractor, and storing the calculated frequency of the identifiers in the identifier name DB.

To achieve another object of the present disclosure, a computer-readable storage medium according to an embodiment has a computer program stored thereon, the computer program for performing the obfuscated identifier detection method based on natural language processing.

To achieve still another object of the present disclosure, an obfuscated identifier detection apparatus based on natural language processing according to an embodiment includes a smali code converter to convert an input obfuscated apk to smali code level, an obfuscated string inspector to inspect an obfuscated string in identifiers of the smali code acquired from the smali code converter, an obfuscated information extractor to extract information necessary for deobfuscation and frequency of the identifiers when there is the obfuscated string, an identifier name DB to store frequency, type and name information of identifiers calculated from information extracted from an unobfuscated apk, and a renamed string rewriter to acquire and deobfuscate an identifier type name having a most similar frequency in the identifier name DB using the information extracted from the obfuscated information extractor.

In an embodiment of the present disclosure, the smali code converter may convert the dex file acquired through a decompiling process of the Apk to the smali code using baksmali, the smali code being a readable version of application execution code.

In an embodiment of the present disclosure, the obfuscated string inspector may inspect all types in the dex file for the identifiers of package, class, method, field, abstract and implement type of the smali code and transmits a location and name of a target.

In an embodiment of the present disclosure, the obfuscated string inspector may determine the name of 2 letters or less or binary other than English alphabet and numbers in ASCII code value to be obfuscated.

In an embodiment of the present disclosure, the obfuscated information extractor may record the information necessary for deobfuscation in a log file, the information necessary for deobfuscation including at least one information of the apk name, the obfuscated name, the type, the number of code lines, a list of functions included in the method or a location address of a target.

In an embodiment of the present disclosure, when the inspection is performed for all types and the recording of the obfuscated information in the log file is completed, the obfuscated information extractor may calculate the frequency of the identifiers using a TF-IDF algorithm which is a natural language processing algorithm to split a string for each obfuscated information and calculate a ratio value of how many times the corresponding character appears in an entire document, and record the calculated frequency of the identifiers in the log file.

In an embodiment of the present disclosure, the obfuscated identifier detection apparatus based on natural language processing may further include an identifier data extractor to receive an input unobfuscated apk, extract names and code from identifiers of package, class, method, field, abstract and implement type, and store in the identifier name DB.

In an embodiment of the present disclosure, the obfuscated identifier detection apparatus based on natural language processing may further include a code frequency calculator to calculate the frequency of the identifiers using a TF-IDF algorithm which is a natural language processing algorithm based on the names and code extracted through the identifier data extractor.

### Advantageous Effects

According to the obfuscated identifier detection method based on natural language processing, it can help reduce delay in analysis and achieve faster analysis by automatically renaming the code that is difficult to understand due to identifier conversion obfuscation. Additionally, it is expected to deobfuscate the existing limited names into more meaningful names by analyzing a large number of samples and storing and managing data. It is expected that it will be very helpful for the industries required to quickly deal with many newly emerging malicious codes.

### DESCRIPTION OF DRAWINGS

FIG. 1 is a block diagram of an obfuscated identifier detection apparatus based on natural language processing according to an embodiment of the present disclosure.

FIG. 2 is a diagram for describing the operation of the obfuscated identifier detection apparatus of FIG. 1.

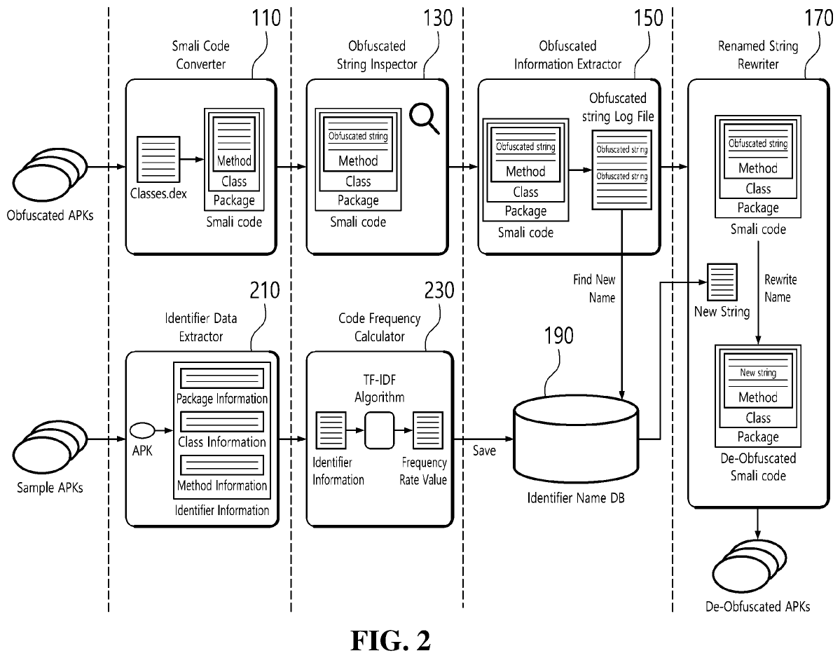

FIG. 3 is a diagram showing table information of an identifier name database (DB) of FIG. 1.

FIG. 4 is a diagram showing the main functions and functions of a deobfuscator tool according to the present disclosure.

FIG. 5 is a flowchart of an obfuscated identifier detection method based on natural language processing according to an embodiment of the present disclosure.

### BEST MODE

The following detailed description of the present disclosure is made with reference to the accompanying drawings, in which particular embodiments for practicing the present disclosure are shown for illustration purposes. These embodiments are described in sufficiently detail for those skilled in the art to practice the present disclosure. It should be understood that various embodiments of the present disclosure are different but do not need to be mutually exclusive. For example, particular shapes, structures, and features described herein in connection with one embodiment may be embodied in other embodiment without departing from the spirit and scope of the present disclosure. It should be further understood that changes may be made to the positions or placement of individual elements in each disclosed embodiment without departing from the spirit and scope of the present disclosure. Accordingly, the following detailed description is not intended to be taken in limiting senses, and the scope of the present disclosure, if appropriately described, is only defined by the appended claims along with the full scope of equivalents to which such claims are entitled. In the drawings, similar reference signs denote same or similar functions in many aspects.

Hereinafter, the preferred embodiments of the present disclosure will be described in more detail with reference to the accompanying drawings.

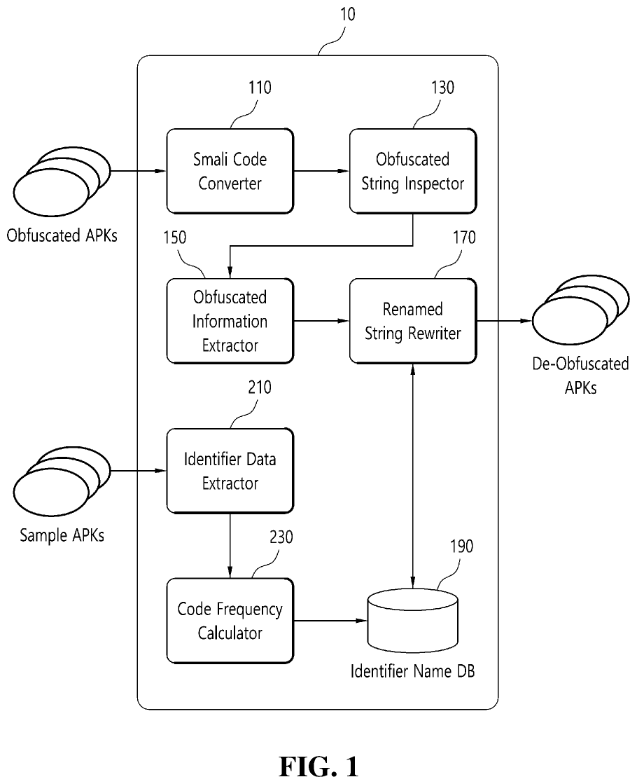

FIG. 1 is a block diagram of an obfuscated identifier detection apparatus based on natural language processing according to an embodiment of the present disclosure.

The obfuscated identifier detection apparatus 10 based on natural language processing (hereinafter apparatus) according to the present disclosure proposes an automated identifier conversion deobfuscator structure using natural language processing.

Referring to FIG. 1, the apparatus 10 according to the present disclosure includes a smali code converter 110, an obfuscated string inspector 130, an obfuscated information extractor 150, an identifier name database (DB) 190 and a renamed string rewriter 170. Additionally, the apparatus 10 of the present disclosure according to another embodiment may further include an identifier data extractor 210 and a code frequency calculator 230.

The apparatus 10 of the present disclosure may run software (application) for automatically performing obfuscated identifier detection based on natural language processing, and the smali code converter 110, the obfuscated string inspector 130, the obfuscated information extractor 150, the identifier name DB 190 and the renamed string rewriter 170 may be controlled by the software for automatically performing obfuscated identifier detection based on natural language processing running in the apparatus 10.

The apparatus 10 may be a separate terminal or a module of the terminal. Additionally, the smali code converter 110, the obfuscated string inspector 130, the obfuscated information extractor 150, the identifier name DB 190 and the renamed string rewriter 170 may be formed as an integrated module or at least one module. However, to the contrary, each element may be formed as a separate module.

The apparatus 10 may be mobile or fixed. The apparatus 10 may be in the form of a server or an engine, and may be interchangeably used with a device, an apparatus, a terminal, user equipment (UE), a mobile station (MS), a wireless device and a handheld device.

The apparatus 10 may execute or create a variety of software based on an Operation System (OS), namely, a system. The OS is a system program for enabling software to use the hardware of the device, and may include mobile computer OS including Android OS, iOS, Windows Mobile OS, Bada OS, Symbian OS and Blackberry OS and computer OS including Windows family, Linux family, Unix family, MAC, AIX and HP-UX.

The smali code converter 110 is a module that converts an input obfuscated apk to smali code level. The apk may be decompiled to a dex file, and the dex file may be converted to smali code using baksmali.

The input obfuscated apk may be decompiled to dex file, asset, resource, androidmanifest.xml file that make up the apk file using the APK Tool. To find an obfuscated string, classes.dex file is converted to smali code level using baksmali. The smali code contains information such as package, class, method and is a readable version of application execution code.

The obfuscated string inspector 130 is a module that inspects an obfuscated string in identifiers of the smali code acquired through the smali code converter 110. The obfuscated string inspector 130 inspects package, class, method, field, abstract, implement type of the smali code and transmits the location and name of a target.

When the conversion to smali code level is completed, inspection is performed to check whether the identifiers are obfuscated. The type of the identifier inspected includes package, class, method, field, abstract, implement, and inspection is performed for all types in the dex file. As the criteria for obfuscation inspection, the name of 2 letters or less or binary other than English alphabet and numbers in ASCII code value may be determined to be obfuscated.

The obfuscated information extractor 150 is a module that extracts information necessary for deobfuscation when the target is obfuscated. The obfuscated information extractor 150 extracts the type information and code of the target and calculates the frequency using a Term Frequency-Inverse Document Frequency (TF-IDF) algorithm.

When there is the obfuscated string found by the obfuscated string inspector 130, information necessary to find a string to deobfuscate is extracted. The extracted information includes the apk name, the obfuscated name, the type, the number of code lines, a list of functions included in method and a location address of the target, and is stored in the extracted log file. When inspection is completed for all types and writing the obfuscated information to the extracted log file is completed, a frequency value is calculated for each obfuscated information using the TF-IDF algorithm. The calculated frequencies are written together in the extracted log file.

The TF-IDF is a method that weights the level of importance for each word in a term document matrix (DTM) using word frequency and inverse document frequency (applying a specific formula for document frequency). The method of use includes building a DTM and TF-IDF weighting.

The TF-IDF may be chiefly used in a task of calculating document similarity, a task of determining the importance of search results in a search system, and a task of calculating the importance of a certain word in a document.

The TF-IDF is a value obtained by multiplying TF by IDF, and writing down the formula for it, when the document is defined as d, the word as t, and the total number of documents as n, TF, DF and IDF may be each defined as below. The TF-IDF formula is as shown in the following Equations 1 and 2.

$$tf ( d , t ) \times log ( \frac{n}{1 + d f ( t )} ) \qquad [ Equation 1 ]$$

Here, tf(d,t) is the number of times the certain word t appears in the certain document d. TF is a value of each word in the example of DTM, and DTM is a value indicating the frequency of each word appearing in each document.

df(t) is defined as the number of documents containing the certain word t. Here, attention is not directed to the number of times the certain word appears in each document or documents, and is only directed to the number of documents containing the certain word t. For example, in DTM, when the word banana in appears in document 1 and document 2, df of banana is 2. The word banana appears twice in document 2, but it is not important, and even though the word banana appears 100 times in document 1 and 200 times in document 2, df of banana is 2.

$$idf ( d , t ) = log ( \frac{n}{1 + d f ( t )} ) \qquad [ Equation 2 ]$$

Here, idf(d, t) is inversely proportional to df(t). When log is not used, in case that IDF is used as an inverse of DF (formula ndf(t)ndf(t)), as the total number of documents n increases, the value of IDF exponentially increases, and log is used to reduce the weight difference.

Additionally, the first reason to add 1 to the denominator in the formula in log is to prevent a situation in which the denominator is 0 when the certain word does not appear in the entire document.

The TF-IDF determines that the importance of a word frequently appearing in all documents is low, and the importance of a word appearing in only a certain document is high. When the TF-IDF value is low, the importance is low, and when the TF-IDF value is high, the importance is high. That is, since stopwords such as “the” or “a” frequently appear in all documents, the value of TF-IDF of stopwords is lower than TF-IDF of other words.

For example, when the total number of documents is 4, the numerator in log is equally 4, and when the word ‘eat’ appears in 2 documents (document 1, document 2), the number of documents (DF) containing each word as the denominator is 2. When comparing the values of IDF for each word, the word appearing in only document 1 and the word appearing in only document 2 have a difference in value. IDF plays a role in lowering the weight of a word appearing in many documents.

Calculating TF-IDF, when DTM is taken as it is, TF of each word in each document is taken as it is, so TF-IDF is calculated by multiplying each word in the previously used DTM by the above IDF value.

Only the TF value of banana in document 2 is 2, so IDF is multiplied by 2, and the remaining TF value is 1, so the IDF value is taken as it is. It can be seen that the TF-IDF weight of banana in document 1 and the TF-IDF weight of banana in document 2 are different from each other.

Mathematically describing, it is because TFs 1 and 2 are different, and from the point of view of TF-IDF, TF-IDF determines a frequently emerging word in a certain document to be an important word in the document. Banana is mentioned once in document 1, but banana is mentioned twice in document 2, and thus banana is determined to be a more important word in document 2.

The renamed string rewriter 170 is a module that retrieves the type name having a similar frequency by searching the identifier name DB 190 using information (for example, type, obfuscated name, location, frequency, etc.) acquired through the obfuscated information extractor 150. The target name is deobfuscated with the name newly obtained through the identifier name DB 190.

For deobfuscation, the present disclosure retrieves information in the extracted log file one by one, searches the identifier name DB 190 to find information having the closest value and retrieves name. To this end, it is necessary to analyze a normal sample and store in the identifier name DB 190, and the identifier data extractor 210 and the code frequency calculator 230 play the role.

The identifier data extractor 210 is a module that receives an input unobfuscated sample apk, extracts necessary information and stores in the DB. The extracted information includes name and code extracted from package, class, method, field, abstract, implement.

The identifier data extractor 210 is a module that receives a large number of input normal APKs, analyzes and extracts necessary information. When extracting information, the identifier data extractor 210 extracts the apk name, the target name, the type, the number of code lines, a list of functions included in method, and a location address of the method.

The code frequency calculator 230 calculates frequency using the code and name extracted through the identifier data extractor 210. The frequency is calculated using the TF-IDF algorithm and all the acquired information is stored in the DB.

The information extracted by the identifier data extractor 210 is transmitted to the code frequency calculator 230 to calculate a value of frequency. When the value of frequency is calculated using the TF-IDF algorithm, the extracted information and frequency is stored in the identifier name DB 190.

The TF-IDF is a natural language processing algorithm that splits a string and calculates a ratio value of the number of occurrences of the corresponding character to the total number of characters. The TF-IDF is used to calculate the frequency of the corresponding information and the included code across the whole.

The identifier name DB 190 is a database that stores and manages the frequency, type and name information calculated from the code frequency calculator 230. To learn more apk to manage more valid names, information is extracted and stored through many apk. The name to deobfuscate is found using the weight value (frequency) and transmitted to the renamed string rewriter 170.

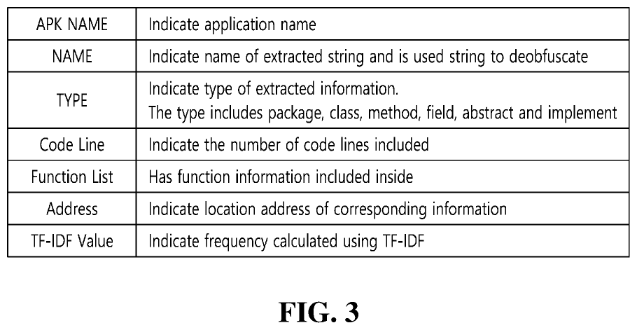

FIG. 3 shows an example of configuration information of the table stored in the identifier name DB 190.

Referring to FIG. 3, there is the extracted information, apk name, name, type, code line, function list, address and tf-idf value, and the extracted information is searched for deobfuscation of obfuscated strings using the same. As there is a larger amount of information, a larger amount of data may be deobfuscated, and thus acquiring a lot of various data by analyzing a large number of samples is the key to improved deobfuscation effect.

When the information of the log file generated by the obfuscated information extractor 150 is searched in the identifier name DB 190, the name having the closest value to the frequency may be retrieved as the result. A new string to be deobfuscated is overwritten to the location of a string to be deobfuscated in the renamed string rewriter 170. This process continues until all information in the obfuscated string log file is deobfuscated. When all types of strings are deobfuscated, compiling and re-packaging using apktool creates a deobfuscated apk.

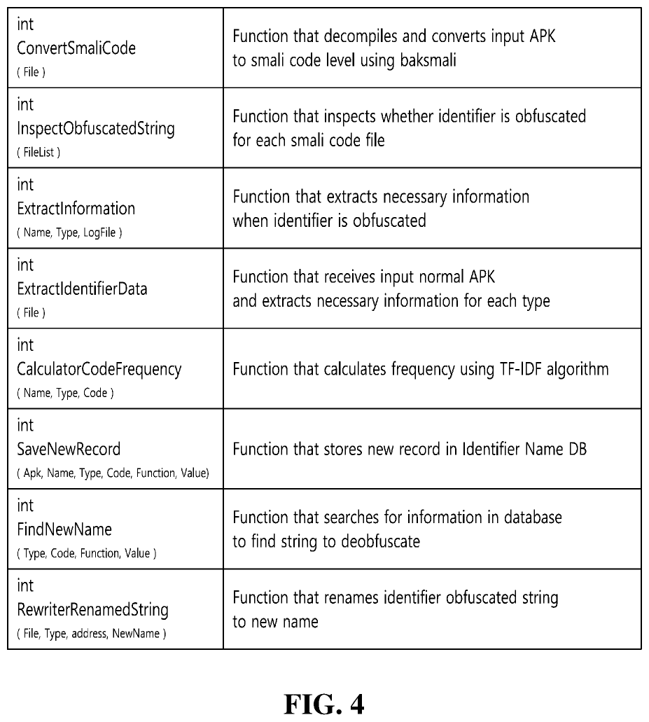

FIG. 4 shows the list of main functions and functions used in the present disclosure. The information in the parentheses indicates parameter information of the function, and int indicates the return type of method.

The present disclosure helps reduce the delay in analysis and achieve faster analysis by automatically renaming the code that is difficult to understand due to identifier conversion obfuscation. Additionally, it is expected to deobfuscate the existing limited names into more meaningful names by analyzing a large number of samples and storing and managing data. It is expected that it will be very helpful for the industries required to quickly deal with many newly emerging malicious codes.

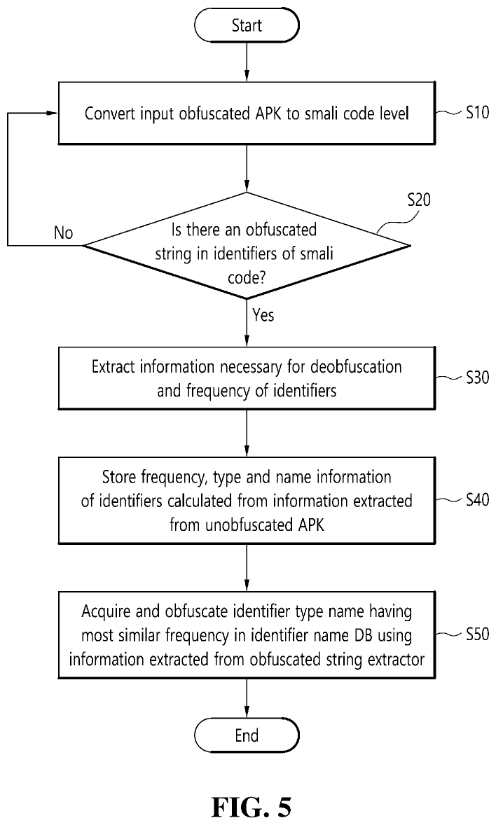

FIG. 5 is a flowchart of an obfuscated identifier detection method based on natural language processing according to an embodiment of the present disclosure.

The obfuscated identifier detection method based on natural language processing according to this embodiment may be performed by substantially the same configuration as the apparatus 10 of FIG. 1. Accordingly, the same reference sign is given to the same elements as the elements of the apparatus 10 of FIG. 1, and redundant descriptions are omitted herein.

Additionally, the obfuscated identifier detection method based on natural language processing according to this embodiment may be performed by the software (application) for performing the obfuscated identifier detection based on natural language processing.

The present disclosure proposes an automated identifier conversion deobfuscation method using natural language processing.

Referring to FIG. 5, the obfuscated identifier detection method based on natural language processing according to this embodiment converts an input obfuscated apk to smali code level (S10).

The step of converting to smali code level includes decompiling the input obfuscated apk to a dex file and converting the acquired dex file to smali code using baksmali, the smali code being a readable version of application execution code.

An obfuscated string in identifiers of the smali code acquired from the smali code converter is inspected (S20), and when there is the obfuscated string, information necessary for deobfuscation and the frequency of the identifiers are extracted (S30).

The step of inspecting the obfuscated string (S20) includes inspecting all types in the dex file for the identifiers of package, class, method, field, abstract and implement type of the smali code. In this case, the name of 2 letters or less or binary other than English alphabet and numbers in ASCII code value may be determined to be obfuscated.

In the step of extracting the information necessary for deobfuscation and the frequency of the identifiers (S30), the information necessary for deobfuscation includes at least one information of the apk name, the obfuscated name, the type, the number of code lines, a list of functions included in method or a location address of the target, and is recorded in a log file.

Additionally, when inspection is performed for all types and the recording of the obfuscated information in the log file is completed, the frequency of the identifiers is calculated using the TF-IDF algorithm which is a natural language processing algorithm for splitting a string for each obfuscated information and calculating a ratio value of how many times the corresponding character appears in the entire document, and the calculated frequency of the identifiers is recorded in log file.

Frequency, type and name information of identifiers calculated from information extracted from an unobfuscated apk is stored (S40), and the identifier type name having the most similar frequency in the identifier name DB is acquired and deobfuscated using information extracted from the obfuscated information extractor (S50).

To this end, names and code are extracted from identifiers of package, class, method, field, abstract and implement type of an input unobfuscated apk and stored in the identifier name DB. Additionally, the frequency of the identifiers is calculated using the TF-IDF algorithm which is a natural language processing algorithm based on the names and code extracted through the identifier data extractor, and the calculated frequency of the identifiers is stored in the identifier name DB.

The obfuscated identifier detection method based on natural language processing may be implemented in the form of applications or program commands that can be executed through a variety of computer components and recorded in computer-readable recording media. The computer-readable recording media may include program commands, data files and data structures, alone or in combination.

The program commands recorded in the computer-readable recording media may be specially designed and configured for the present disclosure and may be those known and available to persons having ordinary skill in the field of computer software.

Examples of the computer-readable recording media include hardware devices specially designed to store and execute the program commands, for example, magnetic media such as hard disk, floppy disk and magnetic tape, optical media such as CD-ROM and DVD, magneto-optical media such as floptical disk, and ROM, RAM and flash memory.

Examples of the program commands include machine code generated by a compiler as well as high-level language code that can be executed by a computer using an interpreter. The hardware device may be configured to act as one or more software modules to perform the processing according to the present disclosure, and vice versa.

While the present disclosure has been hereinabove described with reference to the embodiments, those skilled in the art will understand that various modifications and changes may be made thereto without departing from the spirit and scope of the present disclosure defined in the appended claims.

### INDUSTRIAL APPLICABILITY

The present disclosure helps reduce the delay in analysis and achieve faster analysis by automatically renaming the code that is difficult to understand due to identifier conversion obfuscation. Additionally, it is expected to deobfuscate the existing limited names into more meaningful names by analyzing a large number of samples and storing and managing data. It is expected that it will be very helpful for the industries required to quickly deal with many newly emerging malicious codes.

### DETAILED DESCRIPTION OF MAIN ELEMENTS

10: Obfuscated identifier detection apparatus based on natural language processing

110: Smali code converter

130: Obfuscated string inspector

150: Obfuscated information extractor

170: Renamed string rewriter

190: Identifier name DB

210: Identifier data extractor

230: Code frequency calculator

1-15. (canceled)

16. An obfuscated identifier detection method based on natural language processing, the method comprising:
converting an input obfuscated apk to smali code level using a smali code converter;
inspecting an obfuscated string in identifiers of the smali code acquired from the smali code converter;
extracting information necessary for deobfuscation and frequency of the identifiers when there is the obfuscated string using an obfuscated information extractor;
storing frequency, type, and name information of identifiers calculated from information extracted from an unobfuscated apk; and
deobfuscating by acquiring an identifier type name having a most similar frequency in an identifier name database (DB) using the information extracted from the obfuscated information extractor.

17. The obfuscated identifier detection method of claim 16, wherein the converting the input obfuscated apk to the smali code level comprises:
acquiring a dex file by decompiling the input obfuscated apk; and
converting the acquired dex file to the smali code using baksmali, the smali code being a readable version of application execution code.

18. The obfuscated identifier detection method of claim 17, wherein the inspecting the obfuscated string comprises inspecting all types in the dex file for the identifiers of package, class, method, field, abstract, and implement type of the smali code.

19. The obfuscated identifier detection method of claim 18, wherein the inspecting the obfuscated string further comprises determining obfuscation when a length of a name is two letters or less or when an ASCII code value is binary other than English alphabet and numbers.

20. The obfuscated identifier detection method of claim 16, wherein the extracting the information necessary for deobfuscation and the frequency of the identifiers comprises recording the information necessary for deobfuscation in a log file, the information necessary for deobfuscation including at least one information of an apk name, an obfuscated name, a type, a number of code lines, a list of functions included in a method or a location address of a target.

21. The obfuscated identifier detection method of claim 20, wherein the extracting the information necessary for deobfuscation and the frequency of the identifiers further comprises:
when the inspection is performed for all types and the recording of the obfuscated information in the log file is completed, calculating the frequency of the identifiers using a Term Frequency-Inverse Document Frequency (TF-IDF) algorithm which is a natural language processing algorithm which splits a string for each obfuscated information and calculates a ratio value of a frequency of appearance of a corresponding character compared to an entire document; and
recording the calculated frequency of the identifiers in the log file.

22. The obfuscated identifier detection method of claim 16, further comprising:
receiving an input unobfuscated apk, extracting names and code in identifiers of package, class, method, field, abstract, and implement type using an identifier data extractor, and storing in the identifier name DB.

23. The obfuscated identifier detection method of claim 22, further comprising:
calculating the frequency of the identifiers using a TF-IDF algorithm which is a natural language processing algorithm based on the names and code extracted through the identifier data extractor; and
storing the calculated frequency of the identifiers in the identifier name DB.

24. A non-transitory computer-readable storage medium having a computer program stored thereon, the computer program for performing an obfuscated identifier detection method based on natural language processing, wherein the method comprises:
converting an input obfuscated apk to smali code level using a smali code converter;
inspecting an obfuscated string in identifiers among smali code acquired from the smali code converter;
extracting information necessary for deobfuscation and frequency of the identifiers when there is the obfuscated string using an obfuscated information extractor;
storing frequency, type, and name information of identifiers calculated from information extracted from an unobfuscated apk; and
deobfuscating by acquiring an identifier type name having a most similar frequency in an identifier name database (DB) using the information extracted from the obfuscated information extractor.

25. An obfuscated identifier detection apparatus based on natural language processing, the apparatus comprising:
a smali code converter converting an input obfuscated apk to smali code level;
an obfuscated string inspector inspecting an obfuscated string in identifiers of smali code acquired from the smali code converter;
an obfuscated information extractor extracting information necessary for deobfuscation and frequency of the identifiers when there is the obfuscated string;
an identifier name database (DB) storing frequency, type, and name information of identifiers calculated from information extracted from an unobfuscated apk; and
a renamed string rewriter deobfuscating by acquiring an identifier type name having a most similar frequency in the identifier name DB using the information extracted from the obfuscated information extractor.

26. The obfuscated identifier detection apparatus of claim 25, wherein the smali code converter converts a dex file acquired through a decompiling process of the Apk to the smali code using baksmali, the smali code being a readable version of application execution code, and
wherein the obfuscated string inspector inspects all types in the dex file for the identifiers of package, class, method, field, abstract, and implement type of the smali code, and transmits a location and a name of a target.

27. The obfuscated identifier detection apparatus of claim 26, wherein the obfuscated string inspector determines obfuscation when a length of the name is two letters or less or when an ASCII code value is binary other than English alphabet and numbers.

28. The obfuscated identifier detection apparatus of claim 25, wherein the obfuscated information extractor records the information necessary for deobfuscation in a log file, the information necessary for deobfuscation including at least one information of an apk name, an obfuscated name, a type, a number of code lines, a list of functions included in a method or a location address of a target.

29. The obfuscated identifier detection apparatus of claim 28, wherein when the inspection is performed for all types and the recording of the obfuscated information in the log file is completed, the obfuscated information extractor calculates the frequency of the identifiers using a Term Frequency-Inverse Document Frequency (TF-IDF) algorithm which is a natural language processing algorithm which splits a string for each obfuscated information and calculates a ratio value of a frequency of appearance of a corresponding character compared to an entire document, and records the calculated frequency of the identifiers in the log file.

30. The obfuscated identifier detection apparatus of claim 25, further comprising:
an identifier data extractor receiving an input unobfuscated apk, extracting names and code from identifiers of package, class, method, field, abstract, and implement type, and storing in the identifier name DB; and
a code frequency calculator calculating the frequency of the identifiers using a TF-IDF algorithm which is a natural language processing algorithm based on the names and code extracted through the identifier data extractor.
